(19) United States
(12) Patent Application Publication
(10) Pub. No.: US 2024/0012095 A1
(43) Pub. Date: Jan. 11, 2024

(54) RADAR SENSING IN A RADIO ACCESS NETWORK

(71) Applicant: Lenovo (Singapore) Pte. Ltd., New Tech Park (SG)

(72) Inventors: Ali Ramadan Ali, Kraiburg am Inn (DE); Ankit Bhamri, Rödermark (DE); Sher Ali Cheema, Ilmenau (DE); Karthikeyan Ganesan, Kronberg im Taunus (DE); Robin Thomas, Bad Nauheim (DE)

(21) Appl. No.: 18/253,567

(22) PCT Filed: Nov. 18, 2021
(86) PCT No.: PCT/IB2021/060725

§ 371 Date: May 18, 2023

Related U.S. Application Data
(60) Provisional application No. 63/115,508, filed on Nov. 18, 2020.

(51) Int. Cl. G01S 7/00; G01S 13/00

(52) U.S. Cl. CPC G01S 7/006; G01S 13/003; G01S 13/426

(57) ABSTRACT

Apparatuses, methods, and systems are disclosed for radar-sensing in a radio access network (“RAN”). One apparatus includes a transceiver and a processor that configures time-frequency resources for radar-sensing in a RAN, the time-frequency resources comprising a radar-sensing slot. The processor receives sensing information and determines an obstacle in a cell based on the radar-sensing information.

### CROSS-REFERENCE TO RELATED APPLICATIONS

This application claims priority to U.S. Provisional Patent Application No. 63/115,508 entitled “RADAR SENSING ASSISTED BEAM MANAGEMENT” and filed on Nov. 18, 2020 for Ali Ramadan Ali, Ankit Bhamri, Sher Ali Cheema, Karthikeyan Ganesan, and Robin Thomas, which application is incorporated herein by reference.

### FIELD

The subject matter disclosed herein relates generally to wireless communications and more particularly relates to enhancing beam management by identifying and localizing radio blockages via radar sensing.

### BACKGROUND

In certain wireless networks, beam-based communication may be supported. Beam management, which includes beam establishment, refinement, and beam failure recovery, may result in a signaling-heavy and time/frequency-consuming process that relies on continuous channel measurement and reporting, especially in the presence of multiple permanent and/or temporary blockages.

### BRIEF SUMMARY

Disclosed are procedures for identifying and localizing radio blockages via radar sensing. Said procedures may be implemented by apparatus, systems, methods, or computer program products.

One method of a User Equipment (“UE”) for radar-sensing in a RAN includes receiving a configuration of time-frequency resources for measurement and reporting of radar-sensing signals. Here, the time-frequency resources include at least one radar-sensing slot and at least one reporting slot. The method includes determining radar-sensing information from radar sensing measurements performed on the at least one radar-sensing slot and reporting the radar-sensing information to a network node using the at least one reporting slot.

One method of a Radio Access Network (“RAN”) node for radar-sensing in a RAN includes configuring time-frequency resources for radar-sensing in a RAN, the time-frequency resources comprising a radar-sensing slot. The method includes receiving radar-sensing information and determining an obstacle (e.g., blockage) in a cell based on the radar-sensing information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for radar-sensing in a radio access network (“RAN”);

FIG. 2 is a diagram illustrating one embodiment of Time-Domain representation of a radar pulse and return echo signal;

FIG. 3A is a diagram illustrating one embodiment of Downlink (“DL”) radar sensing for full-duplex system;

FIG. 3B is a diagram illustrating one embodiment of DL radar sensing for full-duplex system using multiple narrow beams;

FIG. 4 is a diagram illustrating one embodiment of multi-user uplink and/or sidelink (“UL/SL”) sensing for full-duplex system;

FIG. 5A is a diagram illustrating one embodiment of multiple transmit/receive point (“multi-TRP”) DL radar sensing for half-duplex system;

FIG. 5B is a diagram illustrating one embodiment of a slot configuration for DL radar sensing for half-duplex system;

FIG. 6 is a diagram illustrating one embodiment of uplink (“UL”) radar sensing for half-duplex system;

FIG. 7A is a diagram illustrating one embodiment of sidelink (“SL”) radar sensing for half-duplex system;

FIG. 7B is a diagram illustrating one embodiment of a slot configuration for SL radar sensing for half-duplex system;

FIG. 8 is a block diagram illustrating one embodiment of a user equipment apparatus that may be used for radar-sensing in a RAN;

FIG. 9 is a block diagram illustrating one embodiment of a network apparatus that may be used for radar-sensing in a RAN;

FIG. 10 is a flowchart diagram illustrating one embodiment of a first method for radar-sensing in a RAN; and

FIG. 11 is a flowchart diagram illustrating one embodiment of a second method for radar-sensing in a RAN.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for identifying and localizing the blockages via radar sensing that gives a new degree of freedom for the network to perform better beam selection, beam tracking and beam refinement. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For higher frequency ranges, e.g., beyond 52.6 GHz, the problem of blockages is expected to be further escalated since obstacles with different types of material can severely attenuate or block the transmitted signal. Furthermore, the very narrow beams used at high frequencies can be blocked even by small sized obstacles and hence frequent beam failure may occur due to the mobility of the UE or the obstacle.

Disclosed herein are solutions that address these issues and ways for identifying and localizing the blockages via radar sensing that gives a new degree of freedom for the network to perform better beam selection, beam tracking and beam refinement. More specifically, for full-duplex systems, radar sensing assisted beam management is proposed using New Radio (“NR”) downlink, uplink, and/or sidelink (“DL/UL/SL”) signals, for which gNB and/or UEs use their own backscattered transmitted signals for identifying blockages in a specific area of the cell.

Radar sensing can be performed on the DL/UL/SL reference signal (“RS”) resources such as demodulation RS, channel state information RS, and/or sounding RS (“DMRS/CSI-RS/SRS”) that are used for data transmission, or on dedicated radar sensing RS. Dedicated DL/UL/SL radar sensing RS are configured in a periodic transmission where the periodicity of the RS depends on the frequency band/range, beamwidth, mobility of UEs, long term blockage statistics, and/or long-term beam failure statistics.

For half-duplex operation, the network configures plurality of transmit/receive points (“TRPs”) to perform cooperative radar signal transmission and reception using DL signals in configured slots for each transmit/receive point (“TRP”). The network configures plurality of UEs to perform cooperative radar signal transmission and reception using their UL/SL signals. Here, UEs configured to perform radar sensing by gNB are also configured with resources to share the sensing information with the gNB.

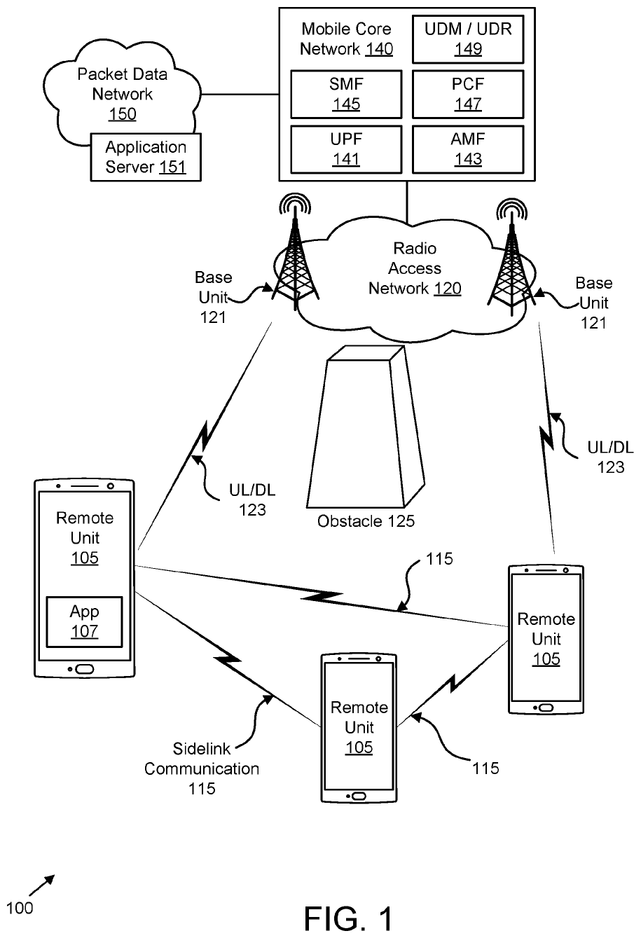

FIG. 1 depicts a wireless communication system 100 for radar-sensing in a RAN, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

In various embodiments, the remote units 105 may communicate directly with each other (e.g., device-to-device communication) using SL communication signals 115. Here, SL transmissions may occur on SL resources. As discussed above, a remote unit 105 may be provided with different SL communication resources for different SL modes. Mode-1 corresponds to a NR network-scheduled SL communication mode. Mode-2 corresponds to an NR UE-scheduled SL communication mode. Examples of SL communication include Vehicle-to-Everything (“V2X”) communications and PC5 communications.

In various embodiments, sidelink transmissions from a “transmitting” remote unit 105 (i.e., Tx UE) may be groupcast or unicast. Groupcast refers to group communications where the transmitting remote unit 105 in the group transits a multicast packet to its group members, where the members of the group belong to the same destination group identifier (“ID”). Each UE (i.e., remote unit 105) in the group will have a member ID. A “receiving” remote unit 105 may provide Hybrid Automatic Repeat Request (“HARQ”) feedback to the transmitting remote unit 105.

In various embodiments, SL communication signals 115 may be sent on frequencies in the Frequency Range #2 (“FR2”) band, e.g., 24.25 GHz to 52.6 GHz. In some embodiments, SL communication signals 115 may be sent on frequencies beyond the FR2 band, e.g., using the ITS band at 60 GHz to 70 GHz. The SL communication signals 115 may include data signals, control information, and/or reference signals.

In certain embodiments, the transmitting remote unit 105 groupcasts using an omnidirectional antenna. In other embodiments, the transmitting remote unit 105 groupcasts data using beam sweeping. As used herein, beam sweeping refers to the transmitting remote unit 105 transmitting the groupcast in predefined directions/beams in sequence, wherein the sequence is indexed and the sequence/index is transmitted as part of the sidelink control channel (e.g., in sidelink control information (“SCI”)). The transmitting remote unit 105 may dynamically signal (in SCI) information about transmission patterns and periodicity. For example, the transmitting remote unit 105 may transmit a signal (e.g., groupcast message) on a first beam during a first set of transmission symbol duration (e.g., first slot), transmit the signal on a second beam during a second set of transmission symbol duration (e.g., second slot), etc.

As mentioned previously, it may happen that a remote unit 105 (i.e., a UE) may experience radio blockages when operating at higher frequency ranges, e.g., beyond 52.6 GHz. Moreover, it is expected that the issue of radio blockages will be escalated at these higher frequencies as compared to lower frequencies because obstacles 125 with different types of material can severely attenuate or block the transmitted signal. Furthermore, the very narrow beams used at high frequencies may be blocked even by small sized obstacles 125 and hence frequent beam failure can occur due to the mobility of the remote unit 105 or the obstacle 125.

In some embodiments, the base units 121 may configure a plurality of remote units 105 to perform radar signal transmission and reception of the reflected signals to identify and localize permanent or temporary obstacles 125 such as a moving object or human or periodically occurring obstacles 125 in a certain area of the cell.

In certain embodiments, the remote units 105 configured to perform radar sensing by a base unit 121 are also configured with resources to share the sensing information with the base unit 121 and can also be configured with duration (such as symbols, slots, frames) for which the remote unit 105 is required to perform sensing.

In various embodiments, radar sensing can be performed on the DL/UL/SL RS resources such as DMRS/CSI-RS/SRS that are used for data transmission, or on dedicated radar sensing RS, or Positioning Reference Signal (“PRS”) and/or adapted radar sensing PRS.

The knowledge of the nature and the location of the blockages can be utilized as extra information for the base unit 121 and/or remote unit(s) 105 entering a specific area to perform better and fast DL/UL/SL beam management that avoids the identified blockages for future transmissions and hence reduces the overhead and latency of performing continuous Channel State Information (“CSI”) measurements and reporting. The information of obstacle(s) 125 can also be used for building/updating a heat map for channel finger printing. The solution is more suitable for NR working at high frequencies (e.g., in the mmWave band) that enable the configuration signaling and reporting of temporal and spatial information of the blockages with high resolution thanks to the large available bandwidth (“BW”) and the use of narrow beams.

While FIG. 1 depicts components of a 5G RAN and a 5G core network, the described embodiments for radar-sensing in a RAN apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for radar-sensing in a RAN.

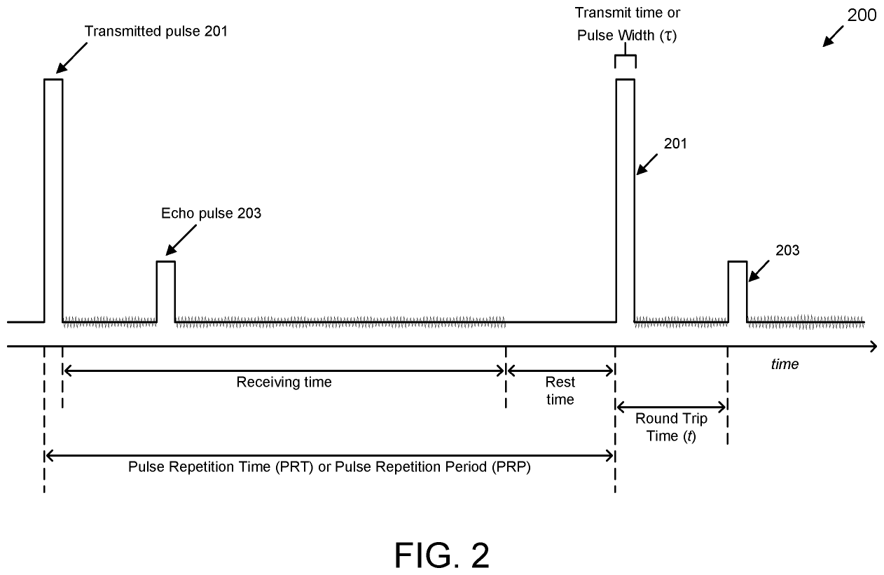

FIG. 2 is a diagram illustrating one embodiment of Time Domain Representation 200 of a Radar Pulse and Return Echo signal, according to embodiments of the disclosure. Communication and Radar technologies have been traditionally deployed as separate/independent systems, each with a separate waveform. There are, however, use cases such as the automotive, smart factory, medical monitoring, etc., where joint radio communications and radar sensing using the same waveform are considered beneficial for efficient usage of the Radio Frequency (“RF”) spectrum as well usage of the same hardware to perform high data rate communications and precise ranging.

Radar systems can be classified into the following categories:
Monostatic radars: A radar system in which the transmitter and receiver are collocated.
Bistatic radar: A radar system that comprises of a transmitter and receiver that are separated by a distance comparable to the expected target distance.
Multistatic radar: A radar system which includes multiple spatially diverse monostatic radar or bistatic radar components within an overlapping coverage area.

Radar signals are characterized by pulses that are modulated onto an RF carrier and are used to detect single/multiple objects that can be resolved in the time domain. FIG. 2 depicts a transmitted pulse 201 having a transmit time, r (also referred to as “Pulse Width”). The reflected signal, referred to as echo pulse 203, is received some time later. In a basic scenario, for a single reflector, a pulse with measured round-trip time t allows the range (R) with respect to the object to be calculated as:

$$R = \frac{ct}{2}$$

while the range resolution (ΔR) is calculated as:

$$Δ R = \frac{c τ}{2}$$

where τ is the pulse width and c is the speed of light. The radar pulses 201 are usually transmitted periodically so that range information can be provided in real time and wait for the returning echo signal during the so-called rest/listening time as shown in FIG. 2. The time between successive radar pulse transmissions is referred to as the Pulse Repetition Time (“PRT”) or Pulse Repetition Period (“PRP”). The PRT may be divided into a receiving time, during which monitoring for the echo pulse 203 occurs, and a rest time.

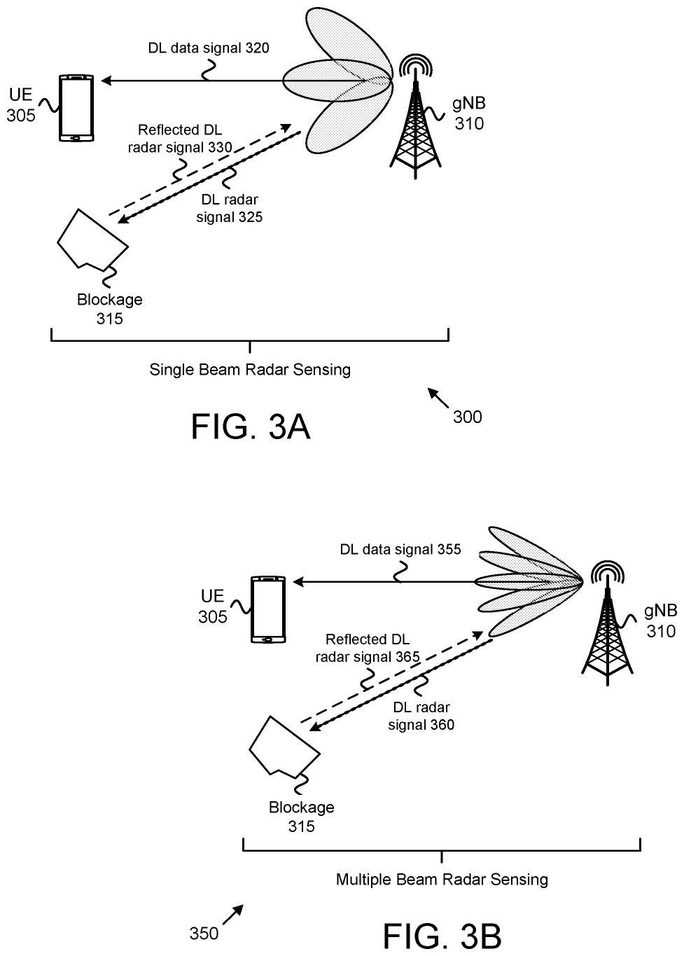

FIGS. 3A-3B depicts DL radar sensing for full-duplex system, according to embodiments of the disclosure. FIGS. 3A-3B illustrate embodiments of a first solution which involves DL radar sensing for a full-duplex capable RAN node (i.e., gNB).

FIG. 3A depicts a system 300 for monostatic radar sensing in a RAN, according to embodiments of the first solution. The system 300 involves a UE 305 served by a gNB 310. A blockage 315 exists within a coverage area of the RAN. The gNB 310 sends a DL data signal 320 and also sends a DL radar signal 325 using a single beam (e.g., utilizing a wide beam). Because the gNB 310 is a full-duplex device, the gNB 310 receives/senses the reflected DL radar signal 330.

FIG. 3B depicts a system 350 for monostatic radar sensing in a RAN, according to embodiments of the first solution. The system 350 involves the UE 305 served by the gNB 310, with the blockage 315 existing within a coverage area of the RAN. The gNB 310 sends a DL data signal 355 and also sends a DL radar signal 360 using a multiple beams (e.g., utilizing multiple narrow beams). Because the gNB 310 is a full-duplex device, the gNB 310 receives/senses the reflected DL radar signal(s) 365.

According to the second solution, a UE equipped with a full-duplex transceiver is configured to perform radar sensing on its own backscattered UL/SL transmission in number of UL/SL slots and measures the channel impulse response to identify and localize the blockage(s). A first implementation may correspond to a monostatic radar sensing feature, where the full-duplex transmitter and receiver are collocated at the UE and the UL/SL transmitted signal and DL echo/backscatter signal are used to determine the location information (e.g., range, absolute positioning, 2D/3D size/dimension) of the blockage(s) within a specified geographical area. Note that the UL/SL signal for radar sensing may be a radar pulse, as depicted in FIG. 2, or may be a longer duration signal.

In another implementation of the second solution, this concept is expanded via joint communication and multi-static radar sensing, such that UL/SL echo signals from multiple spatially diverse monostatic radar or bistatic radar components within an overlapping coverage area may be detected by multiple UEs in a given geographic area.

In some embodiments of the second solution, a full-duplex UE may perform radar sensing in parallel with UL/SL data transmission. In one implementation of the second solution, the UE utilizes the echo/backscatter beamformed UL/SL signals (e.g., demodulation reference signal (“DMRS”), sounding reference signal (“SRS”), and/or SL PRS) configured for the usual UL/SL data transmission and channel measurement.

In some embodiments of the second solution, the full-duplex UE may utilize the echo/backscatter signal of an uplink channel transmission (e.g., Physical Uplink Control Channel (“PUCCH”) and/or Physical Uplink Shared Channel (“PUSCH”)) or sidelink channel transmission (e.g., Physical Sidelink Control Channel (“PSCCH”) and/or Physical Sidelink Shared Channel (“PSSCH”)) for measuring the channel and identifying the blockages. In this implementation, the UE stores a copy of the transmitted PUCCH, PUSCH, PSCCH, and/or PSSCH signal needs to be kept at the UE after the UL/SL transmission to perform channel measurement with respect to the UL/SL echo/backscatter signal to determine the location-related information of the blockage.

In order to avoid the collision/interference with/from DL/SL transmission, the gNB may configure the full-duplex UEs with DL/SL slots/symbols such that there is no overlap with the slots/symbols where the radar sensing is configured.

In another implementation of the second solution, the gNB configures the full-duplex UEs with a specific BWP or number of PRBs for performing radar sensing where no DL or SL transmission from other UEs is configured. After performing channel measurements, the UE reports the related time information to the gNB. The gNB may configure the UEs to perform repetition of radar signal transmission/reception and report the time information after each period or report a combined/averaged measurement information after multiple repetitions.

According to embodiments of the first solution, a gNB (serving or neighboring) equipped with a full-duplex transceiver utilizes its own DL transmission to perform radar sensing on the DL echo/backscattered signal from a certain geographical area/zone of interest. Note that the radar-sensing signal may be a radar pulse, as depicted in FIG. 2, or may be a longer duration signal. A first implementation may correspond to a monostatic radar sensing feature, where the full-duplex transmitter and receiver are collocated at the gNB and the DL transmitted signal and DL echo/backscatter signal are used to determine the location information (e.g., range, absolute positioning, 2D/3D size/dimension) of the blockage(s) within a specified geographical area.

In an alternative implementation, using joint communication and monostatic radar sensing, DL transmissions and echo signals from neighboring gNBs/cells can also be utilized for the purposes of determining one or more blockages of interest and could be shared with the serving gNB via the appropriate interface (e.g., Xn) and/or via a centralized network entity (e.g., Location Management Function and/or Access and Mobility management Function (“LMF/AMF”)). In this case, the respective echo signal can only be specifically detected by the gNB that initially transmitted the initial DL signal.

In a further implementation, this concept is expanded via joint communication and multi-static radar implementation, such that DL echo signals from multiple spatially diverse monostatic radar or bistatic radar components within an overlapping coverage area may be detected by multiple gNBs in a given geographic area.

Specific wideband RS for radar sensing may be configured on some DL time/frequency resources for the gNB 310 to measure the channel impulse response of the DL echo/backscattered signal and subtracts the direct path from the self-leaked signal on the RF circuit and the time/direction information related to out-of-area of interest to identify and localize the blockage(s). The gNB 310 may perform radar sensing in parallel with DL data transmission.

In another implementation of the first solution, the gNB 310 uses the backscattered beamformed DL RS such as DMRS/CSI-RS configured for the usual DL data transmission or a dedicated DL transmission containing only PRS/radar sensing adapted PRS for DL channel measurement.

In another implementation of the first solution, the gNB may utilize the backscattered signal of downlink channel transmission (e.g., Physical Downlink Control Channel (“PDCCH”) and/or Physical Downlink Shared Channel (“PDSCH”)) for measuring the channel and identifying the blockages. In this implementation, a copy of the transmitted PDCCH/PDSCH signal needs to be kept at gNB after the DL transmission to perform channel measurement with respect to the DL echo/backscatter signal to determine the location-related information of the blockage. In order to avoid the collision/interference with/from UL transmissions, gNB may configure the UEs with UL slots that avoid overlapping with the slots where the radar sensing is configured.

In another implementation of the first solution, the gNB configures a specific bandwidth part (“BWP”) or number of physical resource blocks (“PRBs”) for sensing where no UL transmission is configured. The gNB may trigger the radar sensing based on the system need, e.g., to build a heat map as part of channel finger printing stage or based on frequent beam failure of UEs located in a certain area. In another implementation, the gNB may be triggered by another network entity (e.g., LMF).

In one implementation of the first solution, radar sensing specific RS is configured for periodic transmissions, where the periodicity of such RS is based on one or more of the following:
Frequency band/range
Beamwidth
Mobility of UEs
Long terms blockage statistics

In another implementation, radar sensing specific RS transmission is associated with data/control/reference transmission such that before transmission of any scheduled/configured signal in a dedicated slot, sensing specific RS is transmitted on the beams where the transmissions are scheduled.

For Frequency Range #1 (“FR1”, i.e., frequencies from 410 MHz to 7125 MHz), where wide beams are used, the radar sensing and data communication can be performed within the same beam. For FR2 and higher frequency ranges, multiple narrow beams can be generated at the same time and with the same DL configuration, where one beam is used for DL data communication and other beams are used for radar sensing, as shown in FIGS. 3A-3B.

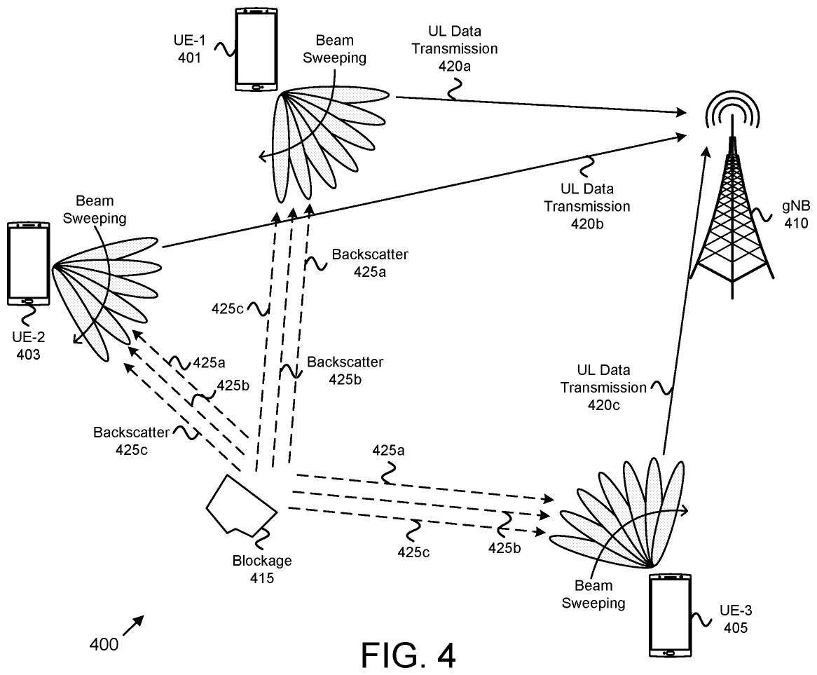

FIG. 4 depicts a system 400 for monostatic radar sensing of multi-user UL signals, according to embodiments of the first solution. Recall, that the second solution which involves UL and/or SL radar sensing for a full-duplex capable UE(s). The system 400 involves a plurality of full-duplex UEs served by a gNB 410. Depicted are a first UE 401 (denoted “UE-1”), a second UE 403 (denoted “UE-2”) and a third UE 405 (denoted “UE-3”). A blockage 415 exists within a coverage area of the RAN.

In order to increase the reliability and accuracy of the radar sensing, the gNB 410 configures the full-duplex UEs 401, 403 and 405 to perform UL data transmission 420 and radar sensing simultaneously. In one embodiment, the gNB 410 configures the group of UEs with a common/user-specific RS for radar sensing. In another embodiment, the gNB 410 configures the group of UEs with a user-specific PUCCH, PUSCH, PSCCH, and/or PSSCH. Here, the data/control signal itself is used for radar sensing, irrespective of any RS present in the PUCCH, PUSCH, PSCCH, and/or PSSCH. In a further embodiment the gNB 410 configure the group of UEs with UL/SL common/user-specific DMRS/SRS or, alternatively, with a PSCCH or PSSCH having a dedicated SL PRS. Note that the UEs 401, 403, and 405 may be selected by the gNB 410 based on their position in the cell.

In the depiction of FIG. 4, the first UE 401 transmits an uplink data signal 420a, the second UE 403 transmits an uplink data signal 420b, and the third UE 405 transmits an uplink data signal 420c. Reflected UL signals corresponding to the uplink data transmission 420a are referred to as backscatter signals 425a. Reflected UL signals corresponding to the uplink data transmission 420b are referred to as backscatter signals 425b. Reflected UL signals corresponding to the uplink data transmission 420c are referred to as backscatter signals 425c. The radar sensing of the blockage 415 via backscatter signals (e.g., signals 425a-425c) and UL data transmissions (e.g., signals 420a-420c) may be performed at the same time by utilizing wide or multiple narrow beams, where an angular range for scanning can be specified by gNB 410 for each user.

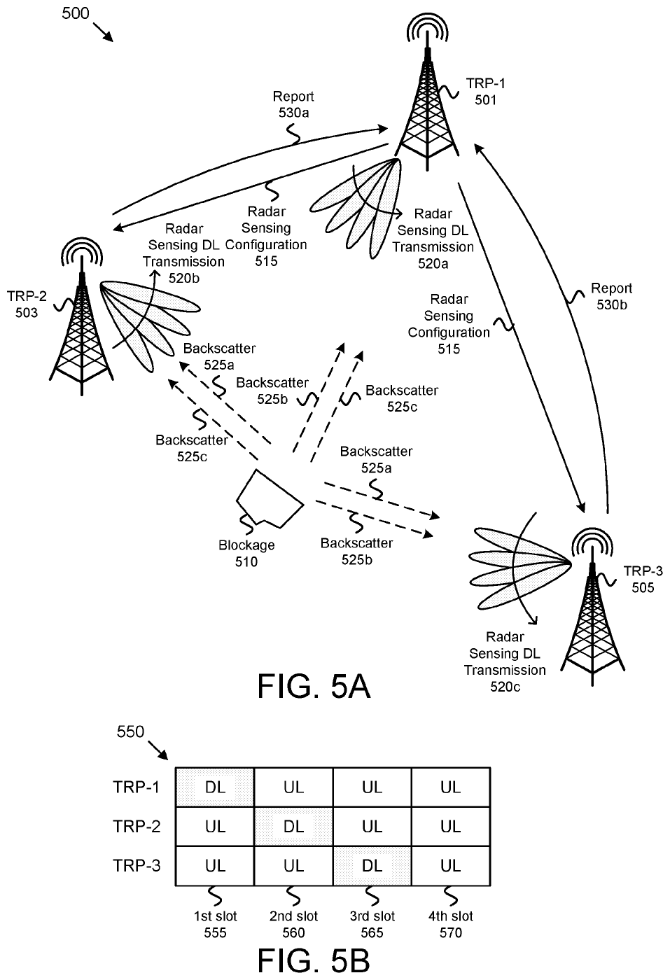

According to the third solution, a plurality of TRPs perform cooperative radar sensing. In one implementation of the third solution, the TRPs are configured with a set of orthogonal RS to perform transmission of radar sensing and synchronized reception of the backscattered signals such that one TRP in one or more DL slots transmits the corresponding RS signal for radar sensing and other TRPs are configured to simultaneously receive the backscatter from the blockage on the same slots as shown in FIG. 5A. Note that the radar-sensing downlink signals may be a radar pulse, as depicted in FIG. 2, or may be a longer duration signal.

In another implementation of the third solution, the TRPs can perform sensing on the DMRS/CSI-RS/PRS resources used by other TRPs for their usual DL transmission. The TRPs in this case need to share their DMRS/CSI-RS resources or in the case of PRS, the resource coordination is handled with assistance of the Location Management Function (“LMF”). To avoid interference from actual UL transmissions from UEs, no UL grants on the configured UL radar sensing slots are given to the connected UEs and the TRPs are configured to utilize these slots for receiving the backscatter of the DL signals from other TRPs.

FIG. 5A depicts DL radar sensing for a half-duplex system 500, according to embodiments of the third solution which involves DL radar sensing for half-duplex TRPs in a RAN. The system 500 involves plurality of TRPs, depicted here as a first TRP 501 (denoted “TRP-1”), a second TRP 503 (denoted “TRP-2”), and a third TRP 505 (denoted “TRP-3”). A blockage 510 exists within a coverage area of the RAN.

In the depicted embodiment, the first TRP 501 configures the second TRP 503 and third TRP 505 to perform cooperative radar sensing (see radar sensing configurations 515). Figure illustrates one example of a time-domain configuration for cooperative radar sensing, i.e., with DL slots to perform radar signal transmissions towards a certain area of interest and UL slots for receiving the backscatter.

According to the configuration, the first TRP 501, the second TRP 503 and the third TRP 505 perform radar signal transmissions towards a certain area of interest (e.g., a suspected location of blockage 510). In one embodiment, the radar signal transmissions are performed using multiple narrow beams in beam-sweeping manner. In another embodiment, the radar signal transmissions are performed by transmitting multiple narrow beams simultaneously. In other embodiments, the radar signal transmissions may be performed using one or more wide beams.

In the depiction of FIG. 5A, the first TRP 501 transmits a downlink data signal 520a, the second TRP 503 transmits a downlink data signal 520b, and the third TRP 505 transmits a downlink data signal 520c. Reflected DL signals corresponding to the downlink data transmission 520a are referred to as backscatter signals 525a. Reflected DL signals corresponding to the downlink data transmission 520b are referred to as backscatter signals 525b. Reflected DL signals corresponding to the downlink data transmission 520c are referred to as backscatter signals 525c.

After performing channel measurements and subtracting the direct paths and the time/direction information related to out-of-area, the second TRP 503 and the third TRP 505 report the time/direction information of the blockage 510 to the first TRP 501. In the depicted embodiment, the second TRP 503 sends the report 530a containing radar-sensing information (i.e., time/direction information) and the third TRP 505 sends the report 530b, also containing radar-sensing information. In some embodiments, the first TRP 501 may configure other TRPs 503, 505 to perform repetition of radar signal transmission/reception and report the time/direction information after each period or report a combined/averaged measurement information after multiple of repetitions. The first TRP 501 combines the time/direction information to identify and localize the blockage 510.

FIG. 5B depicts one example of a time-domain configuration 550 for cooperative radar sensing, according to embodiments of the third solution. Here, the configuration 550 includes DL slots to perform radar signal transmissions towards a certain area of interest and UL slots for receiving the backscatter signals.

As depicted, during a first slot 555 the first TRP 501 is configured with a DL slot and the second TRP 503 and third TRP 505 are configured with UL slots. During a second slot 560 the second TRP 503 is configured with a DL slot and the first TRP 501 and third TRP 505 are configured with UL slots. During a third slot 565 the third TRP 505 is configured with a DL slot and the first TRP 501 and second TRP 503 are configured with UL slots.

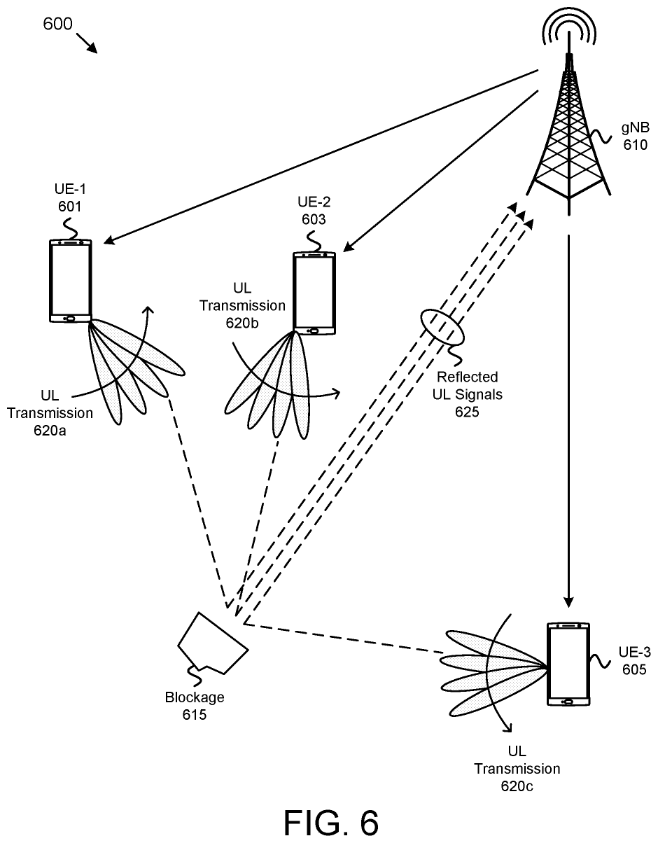

During a fourth slot 570 all three TRPs are configured with UL slots. Note that in some embodiments no TRPs are configured with a DL slot in the fourth slot 570 and no UEs are configured with a UL slot in the fourth slot 570, therefore any signals detected in the fourth slot can be attributed to noise and/or inter-cell (or inter-system) interference. In other embodiments, one or more UEs are configured with UL slots during the fourth slot 570, therefore the TRPs 501, 503 and 505 may receive data and/or control signals from one or more UEs during the fourth slot. According to the fourth solution, the gNB configures plurality of connected UEs to perform UL transmission for radar sensing such that each UE is configured with specific UL resources to transmit DMRS/CSI-RS/SRS for radar sensing. In one implementation, UEs are configured to send Time-Domain Multiplexed radar sensing RS, such that each UE is configured with one or more UL slots for radar signal transmission. In another implementation, each UE is configured to send the radar-sensing RS in number of PRBs of an UL slot. Here, the gNB defines the area for scanning and configures the UEs to direct their UL beams to cover that area, as illustrated in FIG. 6. Note that the radar-sensing RS may be a radar pulse, as depicted in FIG. 2, or may be a longer duration signal.

FIG. 6 depicts UL radar sensing for a half-duplex system 600, according to embodiments of the fourth solution which involves UL radar sensing for a half-duplex gNB 610 and UEs in a RAN. Depicted are a first UE 601 (denoted “UE-1”), a second UE 603 (denoted “UE-2”), and a third UE 605 (denoted “UE-3”). A blockage 615 exists within a coverage area of the RAN.

In the depicted embodiment, the gNB 610 configures the first UE 601 (denoted “UE-1”), the second UE 603 (denoted “UE-2”), and the third UE 605 (denoted “UE-3”) to perform beam sweeping on multiple UL slots to cover the area of interest (e.g., a suspected location of blockage 615). In the depiction of FIG. 6, the first UE 601 transmits uplink signals 620a, the second UE 603 transmits uplink signals 620b, and the third UE 605 transmits uplink signals 620c. Reflected UL signals 625 correspond to the uplink transmissions 620a, the uplink transmissions 620b, and/or the uplink transmissions 620c. The gNB 610 performs channel measurements for each UL transmission 620a-620c, discards the direct paths to the UEs 601-605 (i.e., based on location and/or TA of each UE) and the out-of-area time/direction related information, and combines the available measurements to identify and locate the blockage 615.

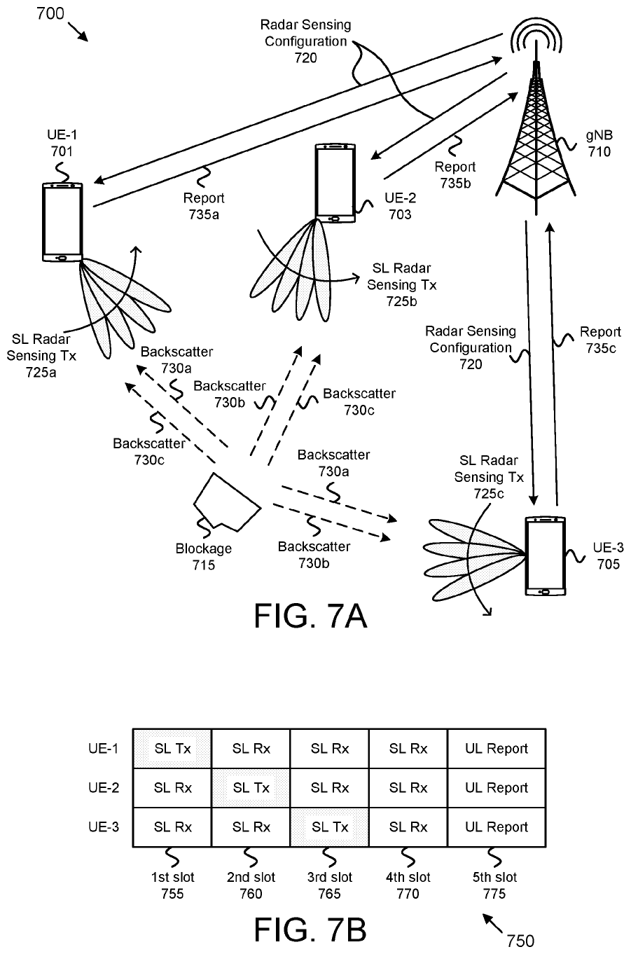

According to the fifth solution, the gNB configures a plurality of UEs to perform SL transmission of radar sensing RS and synchronized reception of the backscattered signals such that one UE in one or more SL slots transmits the corresponding RS signal for radar sensing and other UEs are configured to simultaneously receive the backscatter from the blockage on the same slots as illustrated in FIG. 7A.

FIG. 7A depicts SL radar sensing for half-duplex system 700, according to embodiments of the fifth solution which involves SL radar sensing for half-duplex UEs in a RAN. The system 700 involves a gNB 710 and a plurality of UEs, depicted here as a first UE 701 (denoted “UE-1”), a second UE 703 (denoted “UE-2”), and a third UE 705 (denoted “UE-3”). A blockage 715 exists within a coverage area of the RAN.

In the depicted embodiment, the gNB 710 configures the first UE 701, the second UE 703 and the third UE 705 to perform cooperative radar sensing (see radar sensing configurations 720). If the UEs 701-705 are localized, the gNB 710 may groupcast the location information of the intended UEs. FIG. 7B illustrates one example of a time-domain configuration for cooperative radar sensing, i.e., with SL transmit (“Tx”) slots to perform radar signal transmissions towards a certain area of interest and SL receive (“Rx”) slots for receiving the backscatter signal(s). The gNB 710 also configures the UEs 701-705 with UL slot(s) to report the measurements or the related time/direction information.

According to the configuration, the first UE 701, the second UE 703 and the third UE 705 each perform radar signal transmissions towards a certain area of interest (e.g., a suspected location of blockage 715). In one embodiment, the radar signal transmissions are performed using multiple narrow beams in beam-sweeping manner. In another embodiment, the radar signal transmissions are performed by transmitting multiple narrow beams simultaneously. In other embodiments, the radar signal transmissions may be performed using one or more wide beams.

In the depiction of FIG. 7A, the first UE 701 transmits a sidelink data signal 725a, the second UE 703 transmits a sidelink data signal 725b, and the third UE 705 transmits a sidelink radar-sensing signal 725c. Reflected SL signals corresponding to the sidelink data transmission 725a are referred to as backscatter signals 730a. Reflected SL signals corresponding to the sidelink data transmission 725b are referred to as backscatter signals 730b. Reflected SL signals corresponding to the sidelink data transmission 725c are referred to as backscatter signals 730c.

After performing channel measurements and subtracting the direct paths and the time/direction information related to out-of-area, the Rx UEs report the time/direction information of the blockage to the gNB 710. In the depicted embodiment, the first UE 701 sends the report 735a containing radar-sensing information (i.e., time/direction information), the second UE 703 sends the report 735b containing radar-sensing information, and the third UE 705 sends the report 735c, also containing radar-sensing information. Note that Rx UEs report only time measurement related to the area for scanning, discard out-of-area time information and the direct paths to the Tx UEs. In some embodiments, the gNB 710 may configure the UEs 701-705 to perform repetition of radar signal transmission/reception and report the time information after each period (i.e., after each repetition). Alternatively, the UEs 701-705 may be configured to report a combined/averaged measurement information after multiple of repetitions.

FIG. 7B depicts one example of a time-domain configuration 750 for cooperative radar sensing, according to embodiments of the third solution. Here, the configuration 750 includes SL Tx slots to perform radar signal transmissions towards a certain area of interest and SL Rx slots for receiving the backscatter signals.

As depicted, during a first slot 755 the first UE 701 is configured with a SL Tx slot, while the second UE 703 and third UE 705 are configured with SL Rx slots. During a second slot 760 the second UE 703 is configured with a SL Tx slot, while the first UE 701 and third UE 705 are configured with SL Rx slots. During a third slot 765 the third UE 705 is configured with a SL Tx slot, while the first UE 701 and the second UE 703 are configured with SL Rx slots. During a fourth slot 770 all three UEs are configured with SL Rx slots and in a fifth slot 775 all three UEs are configured with UL slots for reporting radar-sensing information (i.e., time/direction information derived from the radar-sensing measurements). Note that the reporting slots depicted in FIG. 7B may be different for each UE, e.g., depending on network capabilities and/or configuration.

According to a sixth solution, when the gNB configures UEs to perform the reception/transmission of radar sensing signals, then the UEs are also configured with corresponding resources for reporting blockage information based on radar sensing. If the radar sensing is configured in a periodic manner to a UE, then the UE is also expected to periodically report back corresponding measurement/blockage location information.

Measurement information includes counter mentioning one or more of the number of instances when blockage was determined, probability of blockage in specific beam direction, probability of non-blockage, best beam directions based on sensing. Blockage location information may include absolute/relative range/location coordinates, 2D/3D size/dimension, speed/velocity, heading information. In one implementation, a UE uses PUCCH resources for periodic reporting of radar sensing based blockage information. In another implementation, the UE used PUSCH resources for reporting radar sensing based measurements.

In some of the embodiments, a UE is configured by the gNB with starting time and duration thereafter for which the UE is expected to perform sensing. The starting time can be configured with respect to the signaling indication and the duration can either be semi-statically configured or fixed.

Regarding beam management in NR, beam management is defined as a set of Layer 1/2 procedures to acquire and maintain a set of beam pair links, i.e., a beam used at transmit-receive point(s) (TRP(s)) for BS side paired with a beam used at UE. The beam pair links can be used for downlink (DL) and uplink (UL) transmission/reception. The beam management procedures include at least the following six aspects:
Beam sweeping: operation of covering a spatial area, with beams transmitted and/or received during a time interval in a predetermined way.
Beam measurement: for TRP(s) or UE to measure characteristics of received beamformed (“BF”) signals
Beam reporting: for UE to report information of BF signal(s) based on beam measurement
Beam determination: for TRP(s) or UE to select of its own Tx/Rx beam(s)
Beam maintenance: for TRP(s) or UE to maintain the candidate beams by beam tracking or refinement to adapt to the channel changes due to UE movement or blockage.
Beam recovery: for UE to identify new candidate beam(s) after detecting beam failure and subsequently inform TRP of beam recovery request with information of indicating the new candidate beam(s)

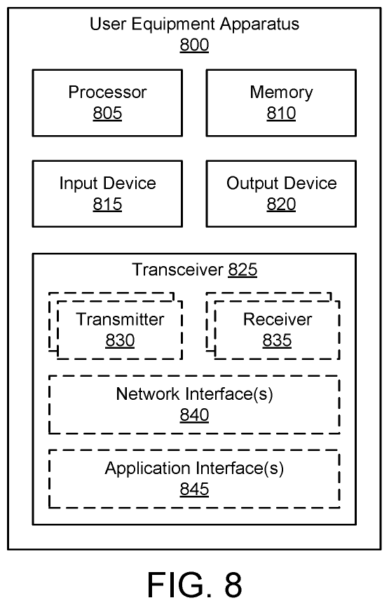

FIG. 8 depicts a user equipment apparatus 800 that may be used for radar-sensing in a RAN, according to embodiments of the disclosure. In various embodiments, the user equipment apparatus 800 is used to implement one or more of the solutions described above. The user equipment apparatus 800 may be one embodiment of the remote unit 105, the UE 305, the first UE 401, the second UE 403, the third UE 405, the first UE 601, the second UE 603, the third UE 605, the first UE 701, the second UE 703, the third UE 705, and/or the user equipment apparatus 800, described above. Furthermore, the user equipment apparatus 800 may include a processor 805, a memory 810, an input device 815, an output device 820, and a transceiver 825.

In some embodiments, the input device 815 and the output device 820 are combined into a single device, such as a touchscreen. In certain embodiments, the user equipment apparatus 800 may not include any input device 815 and/or output device 820. In various embodiments, the user equipment apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. In some embodiments, the transceiver 825 communicates with one or more cells (or wireless coverage areas) supported by one or more base units 121. In various embodiments, the transceiver 825 is operable on unlicensed spectrum. Moreover, the transceiver 825 may include multiple UE panels supporting one or more beams. Additionally, the transceiver 825 may support at least one network interface 840 and/or application interface 845. The application interface(s) 845 may support one or more APIs. The network interface(s) 840 may support 3GPP reference points, such as Uu, N1, PC5, etc. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the processor 805 controls the user equipment apparatus 800 to implement the above described UE behaviors. In certain embodiments, the processor 805 may include an application processor (also known as “main processor”) which manages application-domain and operating system (“OS”) functions and a baseband processor (also known as “baseband radio processor”) which manages radio functions.

In various embodiments, the processor 805 controls the transceiver 825 to receive (e.g., via an air/radio interface) a configuration of time-frequency resources for measurement and reporting of radar-sensing signals, the time-frequency resources containing at least one radar-sensing slot and at least one reporting slot. The processor 805 determines radar-sensing information from radar sensing measurements performed on the at least one radar-sensing slot and reports the radar-sensing information to a network node using the at least one reporting slot.

In some embodiments, the UE device includes a full-duplex transceiver 825. In such embodiments, receiving the configuration of time-frequency resources includes receiving a configuration of resources (e.g., UL/SL resources) for transmission of a radar-sensing signal. In various embodiments, the radar-sensing signal may be a specific radar-sensing RS, a DMRS/SRS, a PUSCH/PUCCH transmission, or a combination thereof.

In some embodiments, the processor 805 receives area-of-interest information, said information containing direction information and time delay range information. In such embodiments, determining the radar-sensing information includes discarding out-of-area delay information. In one embodiment, reporting the radar-sensing information occurs after each measurement. In another embodiment, reporting the radar-sensing information includes sending a combined report after multiple measurements.

In some embodiments, reporting the radar-sensing information from the set of UEs includes sending UCI on a physical uplink channel (e.g., PUCCH or PUSCH), where the configured resources for measurement and reporting of radar-sensing RS include one of: periodic UL resources for reporting radar-sensing measurement, semi-static UL resources for reporting radar-sensing measurement, and aperiodic UL resources for reporting radar-sensing measurement.

In some embodiments, receiving the configuration of time-frequency resources includes receiving area-of-interest information and receiving a configuration of resources for transmitting a radar-sensing RS on radar-sensing specific UL slots, said area-of-interest information containing direction information. In certain embodiments, the processor 805 controls the transceiver 825 to transmit UL radar-sensing RS using beam sweeping towards the area of interest. In such embodiments, determining the radar-sensing information includes measuring reflected UL signals of the group of UEs on corresponding UL slots.

In some embodiments, the received configuration of time-frequency resources includes a SL Tx resource to transmit a radar-sensing RS and configured with one or more SL Rx resources to measure radar sensing RS from at least one other UE.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to radar-sensing in a RAN and/or mobile operation. For example, the memory 810 may store various parameters, panel/beam configurations, resource assignments, policies, and the like as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the user equipment apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 communicates with one or more network functions of a mobile communication network via one or more access networks. The transceiver 825 operates under the control of the processor 805 to transmit messages, data, and other signals and also to receive messages, data, and other signals. For example, the processor 805 may selectively activate the transceiver 825 (or portions thereof) at particular times in order to send and receive messages.

The transceiver 825 includes at least transmitter 830 and at least one receiver 835. One or more transmitters 830 may be used to provide UL communication signals to a base unit 121, such as the UL transmissions described herein. Similarly, one or more receivers 835 may be used to receive DL communication signals from the base unit 121, as described herein. Although only one transmitter 830 and one receiver 835 are illustrated, the user equipment apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

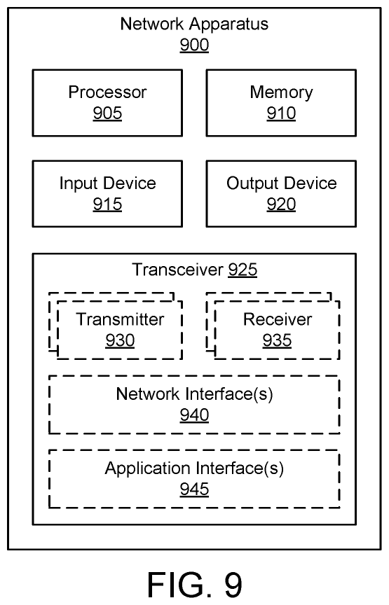

FIG. 9 depicts a network apparatus 900 that may be used for radar-sensing in a RAN, according to embodiments of the disclosure. In one embodiment, network apparatus 900 may be one implementation of a RAN device, such as the base unit 121, the gNB 310, the gNB 410, the first TRP 501, the gNB 610, and/or the gNB 710, as described above. Furthermore, the network apparatus 900 may include a processor 905, a memory 910, an input device 915, an output device 920, and a transceiver 925.

In some embodiments, the input device 915 and the output device 920 are combined into a single device, such as a touchscreen. In certain embodiments, the network apparatus 900 may not include any input device 915 and/or output device 920. In various embodiments, the network apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 communicates with one or more remote units 105. Additionally, the transceiver 925 may support at least one network interface 940 and/or application interface 945. The application interface(s) 945 may support one or more APIs. The network interface(s) 940 may support 3GPP reference points, such as Uu, N1, N2 and N3. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the network apparatus 900 is a RAN node (e.g., gNB) that communicates with one or more UEs, as described herein. In such embodiments, the processor 905 controls the network apparatus 900 to perform the above described RAN behaviors. When operating as a RAN node, the processor 905 may include an application processor (also known as “main processor”) which manages application-domain and operating system (“OS”) functions and a baseband processor (also known as “baseband radio processor”) which manages radio functions.

In various embodiments, the processor 905 controls the apparatus 900 to implement the above gNB and/or TRP functions. In some embodiments, the processor 905 configures time-frequency resources for radar-sensing in a RAN, where the time-frequency resources include at least one radar-sensing slot. In one embodiment, the configured time-frequency resources include a downlink slot for transmission of a signal for radar-sensing (e.g., radar-sensing RS). In another embodiment, the configured time-frequency resources include an uplink slot (or sidelink transmit slot) for transmission of a signal for radar-sensing. In further embodiments, the configured time-frequency resources may include a slot (e.g., DL slot, UL slot or SL Rx slot) for performing radar sensing measurements.

The processor 905 receives receiving radar-sensing information. In one embodiment, the transceiver 925 receives a backscatter signal from a radar-sensing transmission. In another embodiment, the processor 905 receives a report (e.g., from a TRP and/or UE) that contains the radar-sensing information (e.g., measurements made by the reporting device). Where the radar sensing measurements are performed by a device other than the apparatus 900, the configured time-frequency resources may include resources for reporting radar-sensing information. The processor 905 determines an obstacle (e.g., blockage) in a cell based on the radar-sensing information.

In some embodiments, the apparatus 900 comprises a full-duplex transceiver 925. In such embodiments, the transceiver 925 may transmit a dedicated DL RS for radar sensing on the configured time-frequency resources and receive a backscattered signal of the dedicated DL RS for radar sensing. In certain embodiments, a periodicity of the dedicated DL RS based on one or more of: a frequency range containing the DL RS, a beam width of the DL RS, and long-term beam failure statistics.

In other embodiments, the full-duplex transceiver 925 transmits the physical downlink channel on the configured time-frequency resources, wherein receiving the radar-sensing information using a includes receiving a backscattered physical downlink channel (e.g., a PDSCH/PDCCH transmission). In such embodiments, the processor 905 stores a copy of the transmitted physical downlink channel and performs channel measurement using the copy of the transmitted physical downlink channel and the received backscattered signal.

In some embodiments, configuring the time-frequency resources includes configuring a specific BWP (alternatively, a set of PRBs) for transmission and measurement of radar-sensing RS and configuring a different BWP (alternatively, a set of PRBs) for data transmission. In certain embodiments, configuring the time-frequency resources further includes configuring at least one specific beam for transmission and measurement of radar-sensing RS and configuring at least one other beam for data transmission. Note that the beam configuration is independent of the time-frequency configuration and may be in the same slot or a different slot.

In some embodiments, configuring the time-frequency resources includes indicating an area of interest and configuring a plurality of half-duplex TRPs with resources for the transmission, measurement and reporting of orthogonal radar-sensing RS in radar-sensing specific resources. In such embodiments, receiving the radar-sensing information includes receiving reporting from the plurality of half-duplex TRPs, said reporting containing measurements of the radar-sensing RS performed by each TRP. In order to avoid interference during the radar sensing measurement of UL slots by TRPs, UEs are not expected to be configured with UL grant.

In certain embodiments, each TRP is configured to transmit radar-sensing RS in one or more DL slots and measure the RS signals from at least one other TRP on configured one or more UL slots. Further, in such embodiments, the processor 905 reports measurements of the radar-sensing RS from the at least one other TRP. In one embodiment, the processor 905 receives a measurement report from a TRP, where the measurement report combines multiple measurements from multiple TRPs.

In some embodiments, the processor 905 selects a set of (e.g., one or more) full-duplex UE devices based on a location relative to an area of interest. In such embodiments, configuring the time-frequency resources includes configuring the set of full-duplex UE devices with resources (e.g., UL/SL resources) for the transmission, measurement and reporting of radar-sensing RS. In various embodiments, the radar-sensing signal may be a specific radar-sensing RS, a DMRS/SRS, a PUSCH/PUCCH transmission, or a combination thereof.

In some embodiments, configuring the time-frequency resources includes configuring a set of (e.g., one or more) UE devices with resources for measurement and reporting of radar-sensing RS. In certain embodiments, receiving the radar-sensing information includes receiving reporting from the set of UE devices (e.g., after each measurement or a combined report after multiple measurements). In such embodiments, the processor 905 further configures a UE with area-of-interest information. This information may include direction information and/or time-delay range information for the UE to discard the out-of-area delay information from the measurement report.

In certain embodiments, the reporting from the set of UEs includes a report sent in UCI on a physical uplink channel (e.g., PUCCH or PUSCH). In certain embodiments, the configured resources for measurement and reporting of radar-sensing RS include one of: periodic UL resources for reporting radar-sensing measurement, semi-static UL resources for reporting radar-sensing measurement, and aperiodic UL resources for reporting radar-sensing measurement.

In some embodiments, the processor 905 selects a group of (e.g., two or more) UE devices to transmit orthogonal radar-sensing RS in radar-sensing specific resources. In such embodiments, configuring the time-frequency resources includes configuring the group with radar-sensing RS to be transmitted on radar-sensing specific UL slots. In certain embodiments, configuring the time-frequency resources further includes indicating an area of interest and configuring the group of UEs to perform beam sweeping of its UL transmission towards the area of interest. In such embodiments, receiving the radar-sensing information includes performing measurement of reflected UL signals of the group of UEs on corresponding UL slots.

In some embodiments, the processor 905 selects a group of (e.g., two or more) UE devices to transmit radar-sensing RS in orthogonal SL resources. In such embodiments, configuring the time-frequency resources includes configuring the group with radar-sensing RS to be transmitted on radar-sensing specific SL slots. In certain embodiments, each UE device of the group is configured with a SL transmit resource to transmit a radar-sensing RS and configured with one or more SL receive resources to measure radar sensing RS from at least one other UE device.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to radar-sensing in a RAN and/or mobile operation. For example, the memory 910 may store parameters, configurations, resource assignments, policies, and the like, as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display separate from, but communicatively coupled to, the rest of the network apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 includes at least transmitter 930 and at least one receiver 935. One or more transmitters 930 may be used to communicate with the UE, as described herein. Similarly, one or more receivers 935 may be used to communicate with network functions in the Public Land Mobile Network (“PLMN”) and/or RAN, as described herein. Although only one transmitter 930 and one receiver 935 are illustrated, the network apparatus 900 may have any suitable number of transmitters 930 and receivers 935. Further, the transmitter(s) 930 and the receiver(s) 935 may be any suitable type of transmitters and receivers.

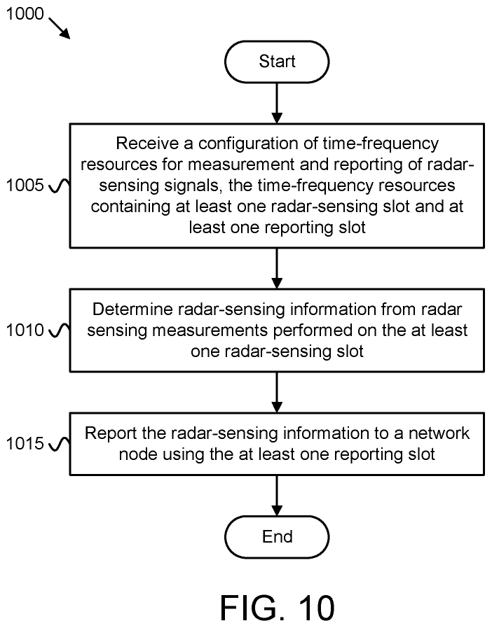

FIG. 10 depicts one embodiment of a method 1000 for radar-sensing in a RAN, according to embodiments of the disclosure. In various embodiments, the method 1000 is performed by a UE device, such as the remote unit 105, the UE 305, the first UE 401, the second UE 403, the third UE 405, the first UE 601, the second UE 603, the third UE 605, the first UE 701, the second UE 703, the third UE 705, and/or the user equipment apparatus 800, described above as described above. In some embodiments, the method 1000 is performed by a processor, such as a microcontroller, a microprocessor, a CPU, a GPU, an auxiliary processing unit, a FPGA, or the like.

The method 1000 begins and receives 1005 a configuration of time-frequency resources for measurement and reporting of radar-sensing signals, the time-frequency resources containing at least one radar-sensing slot and at least one reporting slot. The method 1000 includes determining 1010 radar-sensing information from radar sensing measurements performed on the at least one radar-sensing slot. The method 1000 includes reporting 1015 the radar-sensing information to a network node using the at least one reporting slot. The method 1000 ends.

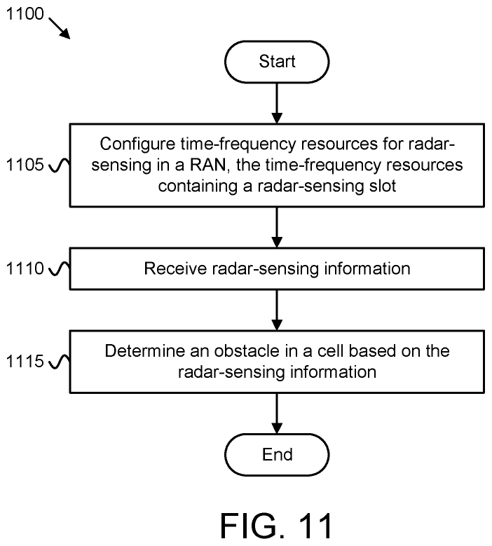

FIG. 11 depicts one embodiment of a method 1100 for radar-sensing in a RAN, according to embodiments of the disclosure. In various embodiments, the method 1100 is performed by a RAN device, such as the base unit 121, the gNB 310, the gNB 410, the first TRP 501, the gNB 610, the gNB 710, and/or the network apparatus 900, described above as described above. In some embodiments, the method 1100 is performed by a processor, such as a microcontroller, a microprocessor, a CPU, a GPU, an auxiliary processing unit, a FPGA, or the like.

The method 1100 begins and configures 1105 time-frequency resources for radar-sensing in a RAN, the time-frequency resources comprising a radar-sensing slot. The method 1100 includes receiving 1110 radar-sensing information. The method 1100 includes determining 1115 an obstacle (e.g., a blockage) in a cell based on the radar-sensing information. The method 1100 ends.

Disclosed herein is a first apparatus for radar-sensing in a RAN, according to embodiments of the disclosure. The first apparatus may be implemented by a RAN device, such as the base unit 121, the gNB 310, the gNB 410, the first TRP 501, the gNB 610, the gNB 710, and/or the network apparatus 900, described above. The first apparatus includes a transceiver and a processor that configures time-frequency resources for radar-sensing in a RAN, the time-frequency resources including a radar-sensing slot. The processor receives radar-sensing information and determines an obstacle (e.g., blockage) in a cell based on the radar-sensing information.

In some embodiments, the network device comprises a full-duplex transceiver. In such embodiments the transceiver transmits a dedicated DL RS for radar sensing on the configured time-frequency resources, where receiving the radar-sensing information includes receiving a backscattered signal of the dedicated DL RS for radar sensing. In certain embodiments, a periodicity of the dedicated DL RS based on one or more of: a frequency range containing the DL RS, a beam width of the DL RS, and long-term beam failure statistics.

In some embodiments, the network device comprises a full-duplex transceiver. In such embodiments, receiving the radar-sensing information includes receiving a backscattered physical downlink channel (e.g., a PDSCH/PDCCH transmission). Moreover, the transceiver transmits the physical downlink channel on the configured time-frequency resources and the processor stores a copy of the transmitted physical downlink channel. In such embodiments, the processor further performs channel measurement using the copy of the transmitted physical downlink channel and the received backscattered signal.

In some embodiments, configuring the time-frequency resources includes configuring a specific BWP (alternatively, a set of PRBs) for transmission and measurement of radar-sensing RS and configuring a different BWP (alternatively, a set of PRBs) for data transmission. In certain embodiments, configuring the time-frequency resources further includes configuring at least one specific beam for transmission and measurement of radar-sensing RS and configuring at least one other beam for data transmission.

In some embodiments, configuring the time-frequency resources includes indicating an area of interest and configuring a plurality of half-duplex TRPs with resources for the transmission, measurement and reporting of orthogonal radar-sensing RS in radar-sensing specific resources. In such embodiments, receiving the radar-sensing information includes receiving reporting from the plurality of half-duplex TRPs, said reporting containing measurements of the radar-sensing RS performed by each TRP. In certain embodiments, each TRP is configured to transmit radar-sensing RS in one or more DL slots and measure the RS signals from at least one other TRP on configured one or more UL slots. Further, in such embodiments, the processor reports measurements of the radar-sensing RS from the at least one other TRP. In one embodiment, the processor receives a measurement report from a TRP, wherein the measurement report combines multiple measurements from multiple TRPs.

In some embodiments, the processor selects a set of (e.g., one or more) full-duplex UE devices based on a location relative to an area of interest. In such embodiments, configuring the time-frequency resources includes configuring the set of full-duplex UE devices with resources (e.g., UL/SL resources) for transmission, measurement and reporting of radar-sensing RS. In various embodiments, the radar-sensing signal may be a specific radar-sensing RS, a DMRS/SRS, a PUSCH/PUCCH transmission, or a combination thereof.

In some embodiments, configuring the time-frequency resources includes configuring a set of (e.g., one or more) UE devices with resources for measurement and reporting of radar-sensing RS. In certain embodiments, receiving the radar-sensing information includes receiving reporting from the set of UE devices. In such embodiments, the processor further configures a UE with area-of-interest information.

In certain embodiments, the reporting from the set of UEs includes a report sent in UCI on a physical uplink channel (e.g., PUCCH or PUSCH). In certain embodiments, the configured resources for measurement and reporting of radar-sensing RS include one of: periodic UL resources for reporting radar-sensing measurement, semi-static UL resources for reporting radar-sensing measurement, and aperiodic UL resources for reporting radar-sensing measurement.

In some embodiments, the processor selects a group of (e.g., two or more) UE devices to transmit orthogonal radar-sensing RS in radar-sensing specific resources. In such embodiments, configuring the time-frequency resources includes configuring the group with radar-sensing RS to be transmitted on radar-sensing specific UL slots. In certain embodiments, configuring the time-frequency resources further includes indicating an area of interest and configuring the group of UEs to perform beam sweeping of its UL transmission towards the area of interest. In such embodiments, receiving the radar-sensing information includes performing measurement of reflected UL signals of the group of UEs on corresponding UL slots.

In some embodiments, the processor selects a group of (e.g., two or more) UE devices to transmit radar-sensing RS in orthogonal SL resources. In such embodiments, configuring the time-frequency resources includes configuring the group with radar-sensing RS to be transmitted on radar-sensing specific SL slots. In certain embodiments, each UE device of the group is configured with a SL transmit resource to transmit a radar-sensing RS and configured with one or more SL receive resources to measure radar sensing RS from at least one other UE device.

Disclosed herein is a first method for radar-sensing in a RAN, according to embodiments of the disclosure. The first method may be performed by a RAN device, such as the base unit 121, the gNB 310, the gNB 410, the first TRP 501, the gNB 610, the gNB 710, and/or the network apparatus 900, described above. The first method includes configuring time-frequency resources for radar-sensing in a Radio Access Network (“RAN”), the time-frequency resources comprising a radar-sensing slot. The first method includes receiving radar-sensing information and determining an obstacle (e.g., blockage) in a cell based on the radar-sensing information.

In some embodiments, the network device comprises a full-duplex transceiver. In such embodiments, the first method includes transmitting a dedicated DL RS for radar sensing on the configured time-frequency resources, where receiving the radar-sensing information includes receiving a backscattered signal of the dedicated DL RS for radar sensing. In certain embodiments, a periodicity of the dedicated DL RS based on one or more of: a frequency range containing the DL RS, a beam width of the DL RS, and long-term beam failure statistics.

In some embodiments, the network device comprises a full-duplex transceiver. In such embodiments, receiving the radar-sensing information includes receiving a backscattered physical downlink channel (e.g., a PDSCH/PDCCH transmission). Moreover, the first method includes transmitting the physical downlink channel on the configured time-frequency resources, storing a copy of the transmitted physical downlink channel, and performing channel measurement using the copy of the transmitted physical downlink channel and the received backscattered signal.

In some embodiments, configuring the time-frequency resources includes configuring a specific BWP (alternatively, a set of PRBs) for transmission and measurement of radar-sensing RS and configuring a different BWP (alternatively, a set of PRBs) for data transmission. In certain embodiments, configuring the time-frequency resources further includes configuring at least one specific beam for transmission and measurement of radar-sensing RS and configuring at least one other beam for data transmission.

In some embodiments, configuring the time-frequency resources includes indicating an area of interest and configuring a plurality of half-duplex TRPs with resources for the transmission, measurement and reporting of orthogonal radar-sensing RS in radar-sensing specific resources. In such embodiments, receiving the radar-sensing information includes receiving reporting from the plurality of half-duplex TRPs, said reporting containing measurements of the radar-sensing RS performed by each TRP. In certain embodiments, each TRP is configured to transmit radar-sensing RS in one or more DL slots and measure the RS signals from at least one other TRP on configured one or more UL slots. Further, in such embodiments, the first method includes reporting measurements of the radar-sensing RS from the at least one other TRP. In one embodiment, the first method includes receiving a measurement report from a TRP, where the measurement report combines multiple measurements from multiple TRPs.

In some embodiments, the first method includes selecting a set of (e.g., one or more) full-duplex UE devices based on a location relative to an area of interest. In such embodiments, configuring the time-frequency resources includes configuring the set of full-duplex UE devices with resources (e.g., UL/SL resources) for transmission, measurement and reporting of radar-sensing RS. In various embodiments, the radar-sensing signal may be a specific radar-sensing RS, a DMRS/SRS, a PUSCH/PUCCH transmission, or a combination thereof.

In some embodiments, configuring the time-frequency resources includes configuring a set of (e.g., one or more) UE devices with resources for measurement and reporting of radar-sensing RS. In certain embodiments, receiving the radar-sensing information includes receiving reporting from the set of UE devices. In such embodiments, the first method includes configuring a UE with area-of-interest information.

In certain embodiments, the reporting from the set of UEs includes a report sent in UCI on a physical uplink channel (e.g., PUCCH or PUSCH). In certain embodiments, the configured resources for measurement and reporting of radar-sensing RS include one of: periodic UL resources for reporting radar-sensing measurement, semi-static UL resources for reporting radar-sensing measurement, and aperiodic UL resources for reporting radar-sensing measurement.

In some embodiments, the first method includes selecting a group of (e.g., two or more) UE devices to transmit orthogonal radar-sensing RS in radar-sensing specific resources. In such embodiments, configuring the time-frequency resources includes configuring the group with radar-sensing RS to be transmitted on radar-sensing specific UL slots. In certain embodiments, configuring the time-frequency resources further includes indicating an area of interest and configuring the group of UEs to perform beam sweeping of its UL transmission towards the area of interest. In such embodiments, receiving the radar-sensing information includes performing measurement of reflected UL signals of the group of UEs on corresponding UL slots.

In some embodiments, the first method includes selecting a group of (e.g., two or more) UE devices to transmit radar-sensing RS in orthogonal SL resources. In such embodiments, configuring the time-frequency resources includes configuring the group with radar-sensing RS to be transmitted on radar-sensing specific SL slots. In certain embodiments, each UE device of the group is configured with a SL transmit resource to transmit a radar-sensing RS and configured with one or more SL receive resources to measure radar sensing RS from at least one other UE device.

Disclosed herein is a second apparatus for radar-sensing in a RAN, according to embodiments of the disclosure. The second apparatus may be implemented by a UE device, such as the remote unit 105, the UE 305, the first UE 401, the second UE 403, the third UE 405, the first UE 601, the second UE 603, the third UE 605, the first UE 701, the second UE 703, the third UE 705, and/or the user equipment apparatus 800, described above. The second apparatus includes a transceiver and a processor that receives a configuration of time-frequency resources for measurement and reporting of radar-sensing signals, the time-frequency resources containing at least one radar-sensing slot and at least one reporting slot. The processor determines radar-sensing information from radar sensing measurements performed on the at least one radar-sensing slot and reports the radar-sensing information to a network node using the at least one reporting slot.

In some embodiments, the UE device includes a full-duplex transceiver. In such embodiments, receiving the configuration of time-frequency resources includes receiving a configuration of resources (e.g., UL/SL resources) for transmission of a radar-sensing signal. In various embodiments, the radar-sensing signal may be a specific radar-sensing RS, a DMRS/SRS, a PUSCH/PUCCH transmission, or a combination thereof.

In some embodiments, the processor receives area-of-interest information, said information containing direction information and time delay range information. In such embodiments, determining the radar-sensing information includes discarding out-of-area delay information. In one embodiment, reporting the radar-sensing information occurs after each measurement. In another embodiment, reporting the radar-sensing information includes sending a combined report after multiple measurements.

In some embodiments, reporting the radar-sensing information from the set of UEs includes sending UCI on a physical uplink channel (e.g., PUCCH or PUSCH), where the configured resources for measurement and reporting of radar-sensing RS include one of: periodic UL resources for reporting radar-sensing measurement, semi-static UL resources for reporting radar-sensing measurement, and aperiodic UL resources for reporting radar-sensing measurement.

In some embodiments, receiving the configuration of time-frequency resources includes receiving area-of-interest information and receiving a configuration of resources for transmitting a radar-sensing RS on radar-sensing specific UL slots, said area-of-interest information containing direction information. In certain embodiments, the processor controls the transceiver to transmit UL radar-sensing RS using beam sweeping towards the area of interest. In such embodiments, determining the radar-sensing information includes measuring reflected UL signals of the group of UEs on corresponding UL slots.

In some embodiments, the received configuration of time-frequency resources includes a SL Tx resource to transmit a radar-sensing RS and configured with one or more SL Rx resources to measure radar sensing RS from at least one other UE.

Disclosed herein is a second method for radar-sensing in a RAN, according to embodiments of the disclosure. The second method may be performed by a UE device, such as the remote unit 105, the UE 305, the first UE 401, the second UE 403, the third UE 405, the first UE 601, the second UE 603, the third UE 605, the first UE 701, the second UE 703, the third UE 705, and/or the user equipment apparatus 800, described above. The second method includes receiving a configuration of time-frequency resources for measurement and reporting of radar-sensing signals. Here, the time-frequency resources include at least one radar-sensing slot and at least one reporting slot. The second method includes determining radar-sensing information from radar sensing measurements performed on the at least one radar-sensing slot and reporting the radar-sensing information to a network node using the at least one reporting slot.

In some embodiments, the UE device includes a full-duplex transceiver. In such embodiments, receiving the configuration of time-frequency resources includes receiving a configuration of resources (e.g., UL/SL resources) for transmission of a radar-sensing signal. In various embodiments, the radar-sensing signal may be a specific radar-sensing RS, a DMRS/SRS, a PUSCH/PUCCH transmission, or a combination thereof.

In some embodiments, the second method includes receiving area-of-interest information, said information containing direction information and time delay range information. In such embodiments, determining the radar-sensing information includes discarding out-of-area delay information. In one embodiment, reporting the radar-sensing information occurs after each measurement. In another embodiment, reporting the radar-sensing information includes sending a combined report after multiple measurements.

In some embodiments, reporting the radar-sensing information from the set of UEs includes sending UCI on a physical uplink channel (e.g., PUCCH or PUSCH), where the configured resources for measurement and reporting of radar-sensing RS include one of: periodic UL resources for reporting radar-sensing measurement, semi-static UL resources for reporting radar-sensing measurement, and aperiodic UL resources for reporting radar-sensing measurement.

In some embodiments, receiving the configuration of time-frequency resources includes receiving area-of-interest information and receiving a configuration of resources for transmitting a radar-sensing RS on radar-sensing specific UL slots, said area-of-interest information containing direction information. In certain embodiments, the second method further includes transmitting UL radar-sensing RS using beam sweeping towards the area of interest. In such embodiments, determining the radar-sensing information includes measuring reflected UL signals of the group of UEs on corresponding UL slots.

In some embodiments, the received configuration of time-frequency resources includes a SL Tx resource to transmit a radar-sensing RS and configured with one or more SL Rx resources to measure radar sensing RS from at least one other UE.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a network device, the method comprising:
configuring time-frequency resources for radar-sensing in a Radio Access Network (“RAN”), the time-frequency resources comprising a radar-sensing slot;
receiving radar-sensing information; and
determining an obstacle in a cell based on the radar-sensing information.

2. The method of claim 1, wherein the network device comprises a full-duplex transceiver, wherein receiving the radar-sensing information comprises receiving a backscattered signal of a dedicated downlink (“DL”) reference signal (“RS”) for radar sensing, the method further comprising:
transmitting the dedicated DL RS for radar sensing on the configured time-frequency resources,
wherein a periodicity of the dedicated DL RS based on one or more of: a frequency range containing the DL RS, a beam width of the DL RS, and long-term beam failure statistics.

3. The method of any preceding claim, wherein the network device comprises a full-duplex transceiver, wherein receiving the radar-sensing information comprises receiving a backscattered physical downlink channel, the method further comprising:
transmitting the physical downlink channel on the configured time-frequency resources;
storing a copy of the transmitted physical downlink channel; and
performing channel measurement using the copy of the transmitted physical downlink channel and the received backscattered signal.

4. The method of any preceding claim, wherein configuring the time-frequency resources comprises configuring a specific Bandwidth Part (“BWP”) for transmission and measurement of radar-sensing reference signal (“RS”) and configuring a different BWP for data transmission.

5. The method of any preceding claim, wherein configuring the time-frequency resources comprises indicating an area of interest and configuring a plurality of half-duplex Transmit-Receive Points (“TRPs”) with resources for transmission, measurement and reporting of orthogonal radar-sensing reference signal (“RS”) in radar-sensing specific resources, wherein receiving the radar-sensing information comprises receiving reporting from the plurality of half-duplex TRPs, said reporting containing measurements of the radar-sensing RS performed by each TRP.

6. The method of claim 5, wherein each TRP is configured to:
transmit radar-sensing RS in one or more downlink (“DL”) slots;
measure the RS signals from at least one other TRP on configured one or more uplink (“UL”) slots; and
report measurements of the radar-sensing RS from the at least one other TRP.

7. The method of claim 5 or 6, further comprising receiving a measurement report from a TRP, wherein the measurement report combines multiple measurements from multiple TRPs.

8. The method of any of claims 1-4, further comprising selecting a set of full-duplex User Equipment (“UE”) devices based on a location relative to an area of interest, wherein configuring the time-frequency resources comprises configuring the set of full-duplex UE devices with resources for transmission, measurement and reporting of radar-sensing reference signal (“RS”).

9. The method of any of claims 1-4, wherein configuring the time-frequency resources comprises configuring a set of User Equipment (“UE”) devices with resources for measurement and reporting of radar-sensing reference signal (“RS”), wherein receiving the radar-sensing information comprises receiving reporting from the set of UE devices, wherein the method further comprises configuring a UE with area-of-interest information.

10. The method of any of claims 1-4, further comprising selecting a group of User Equipment (“UE”) devices to transmit orthogonal radar-sensing reference signal (“RS”) in radar-sensing specific resources, wherein configuring the time-frequency resources comprises configuring the group with radar-sensing RS to be transmitted on radar-sensing specific uplink (“UL”) slots.

11. The method of any of claims 1-4, further comprising selecting a group of User Equipment (“UE”) devices to transmit radar-sensing reference signal (“RS”) in orthogonal Sidelink (“SL”) resources, wherein configuring the time-frequency resources comprises configuring the group with radar-sensing RS to be transmitted on radar-sensing specific SL slots, wherein each UE device of the group is configured with a SL transmit resource to transmit a radar-sensing RS and configured with one or more SL receive resources to measure radar sensing RS from at least one other UE device.

12. A network apparatus comprising:
a transceiver; and
a processor that:
configures time-frequency resources for radar-sensing in a Radio Access Network (“RAN”), the time-frequency resources comprising a radar-sensing slot;
receives receiving radar-sensing information; and
determines an obstacle in a cell based on the radar-sensing information.

13. A method of a User Equipment (“UE”) device, the method comprising:
receiving a configuration of time-frequency resources for measurement and reporting of radar-sensing signals, the time-frequency resources comprising at least one radar-sensing slot and at least one reporting slot;
determining radar-sensing information from radar sensing measurements performed on the at least one radar-sensing slot; and
reporting the radar-sensing information to a network node using the at least one reporting slot.

14. The method of claim 13, wherein the UE device comprises a full-duplex transceiver, wherein receiving the configuration of time-frequency resources comprises receiving a configuration of resources for transmission of a radar-sensing signal.

15. The method of claim 13 or 14, further comprising:
receiving area-of-interest information, said information comprising direction information and time delay range information,
wherein determining the radar-sensing information comprises discarding out-of-area delay information, and
wherein reporting the radar-sensing information comprises one of: reporting after each measurement or reporting a combined report after multiple measurements.
